(19) United States
(12) Patent Application Publication
(10) Pub. No.: US 2009/0288000 A1
(43) Pub. Date: Nov. 19, 2009

(54) INTERACTIVE APPLICATION FOR ACCESSING INFORMATION ABOUT A CONDITION

(75) Inventor: Mark McPherson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SKINTOUR LLC, Seattle, WA (US)

(21) Appl. No.: 12/467,164

(22) Filed: May 15, 2009

Related U.S. Application Data
(60) Provisional application No. 61/053,627, filed on May 15, 2008.

(51) Int. Cl. G06F 3/048; G06F 3/00; G06F 15/16; G06F 15/173

(52) U.S. Cl. 715/704; 715/810; 709/227; 709/224; 707/3; 715/764

(57) ABSTRACT

Generally described, aspects of the disclosed subject matter are directed to computer systems that allow information regarding a condition, such as a skincare condition, to be accessed over the network. In accordance with one embodiment, a method is provided that allows a user associated with the client computing device to obtain information about a condition utilizing an intuitive and readily understandable user interface. In this regard, the method includes providing a user interface having controls that allow the user associated with the client computing device to identify a relevant condition without performing a keyword search. Input identifying the relevant condition is received based on one or more selections of graphical controls available from the user interface. In response, the method causes information associated with the selected condition to be presented to the user.

### CROSS-REFERENCE TO RELATED APPLICATION

This application claims the benefit of Provisional Application No. 61/053,627, filed May 15, 2008, which is hereby incorporated by reference.

### BACKGROUND

Computer networks are well known for providing communications between different computing systems to enable sharing and exchange of data. For example, a computer system may maintain information in Web pages or other resources including, but not limited to, documents, files, databases, etc., that are stored or generated dynamically on local or remote computing systems. In this regard, Web pages are often accessed in reference to a Uniform Resource Identifier (“URI”), such as by entering a Uniform Resource Locator into a Web browser. Moreover, Web pages may also be accessed by sending a File Transfer Protocol (“FTP”) command, or otherwise invoking a computer process to obtain access to a specified network resource. In circumstances when a computer network is involved, a client computing device may access Web pages using a network address that identifies the desired Web page in the computer network. Moreover, computer networks range from local area networks to wide area networks including the global network commonly referred to as the World Wide Web (sometimes referred to as the “Web” or the “Internet”). The Internet, in particular, enables users to access a large number of Web pages and other network-accessible resources.

In the realm of the Internet, typical computer users access Web pages by instructing a Web browser program that executes on a local client computer to transmit a request for the Web page using a URL. Domain name servers direct the Web page request to one or more server computers that correspond to the network domain identified in the URL. When a server computer receives the Web page request, the server computer transmits code that embodies the Web page to the client computer of the requesting user. The user's browser program receives markup and other code used to display the Web page, which typically includes links that reference other network addresses, applications, etc.

Using existing systems to access information related to a condition, such as a skincare condition, is arduous and ultimately too inconvenient or difficult for some users. Each user may have specific attributes (i.e. age, skin color, skin type) as well as different conditions (i.e., moles, sun damage, broken blood vessels, etc.) that are relevant in obtaining information about the condition. In addition, users are not able to readily input this type of data in an intuitive way into a networked computer system. Instead, users may be required to search and analyze text descriptions to obtain information about a particular condition. The time and effort required to perform a manual text-based search may lead to frustration and ultimately prevent users from identifying and seeking the appropriate treatment.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, aspects of the disclosed subject matter are directed to computer systems that allow information regarding a condition, such as a skincare condition, to be accessed over the network. In accordance with one embodiment, a method is provided that allows a user associated with the client computing device to obtain information about a condition utilizing an intuitive and readily understandable user interface. In this regard, the method includes providing a user interface having controls that allow the user associated with the client computing device to identify a relevant condition without performing a keyword search. Input identifying the relevant condition is received based on one or more selections of graphical controls available from the user interface. In response, the method causes information associated with the selected condition to be presented to the user.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is an exemplary pictorial depiction of a networking environment suitable for illustrating aspects of the disclosed subject matter;

FIG. 2 is an exemplary pictorial depiction of an architecture for a computing device depicted in FIG. 1 configured to disseminate information about a condition over the network;

FIG. 3 is an exemplary flow diagram of a method that satisfies requests for information during a network session;

FIGS. 4A-C are exemplary pictorial depictions of Web pages that illustrate aspects of the disclosed subject matter;

FIG. 5 is an exemplary flow diagram of a method for allowing a user to readily access information about a particular condition using graphical controls; and

FIG. 6 is an exemplary pictorial depiction of a Web page suitable to illustrate additional aspects of the disclosed subject matter.

### DETAILED DESCRIPTION

Aspects of the disclosed subject matter may be described in the general context of computer-executable instructions, such as program modules, being executed by a computer. Generally described, program modules include routines, programs, applications, controls, widgets, objects, components, data structures, etc., that perform tasks or implement particular abstract data types. Moreover, the disclosed subject matter will typically be implemented in distributed computing environments where tasks are performed by remote processing devices that are linked through a communications network. In a distributed computing environment, program modules may be located on local and/or remote computer storage media.

The following detailed description provides exemplary implementations of the disclosed subject matter. Although specific system configurations and flow diagrams are illustrated, it should be understood that the examples provided herein are not exhaustive and do not limit the claimed subject matter to the precise forms disclosed. Persons having ordinary skill in the art will recognize that components and method steps described herein may be interchangeable with other components or steps, or combinations of components or steps, and still achieve the benefits and advantages of the disclosed subject matter. It should also be understood that the following description is presented largely in terms of logic and operations that may be performed by conventional computer components. These computer components, which may be grouped in a single location or distributed over a wide area, generally include computer processors, memory, storage devices, display devices, input devices, etc. In circumstances where the computer components are distributed, the computer components are accessible to each other via network-accessible communication links.

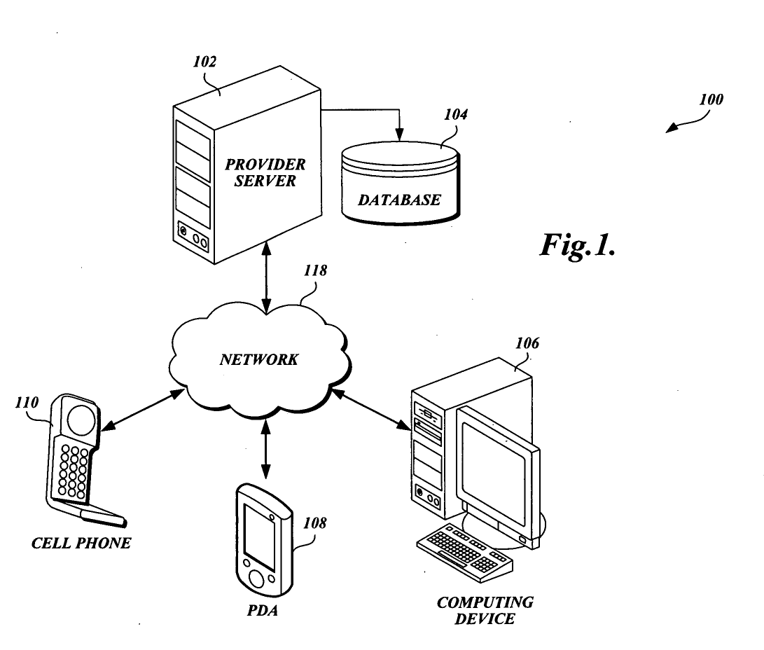

Now with reference to FIG. 1 a brief, general description of a networking environment 100 suitable to implement aspects of the disclosed subject matter will be described. As illustrated in FIG. 1, the networking environment 100 is comprised of a plurality of computers, namely, the provider server 102 associated with the database 104, the client computing device 106, the personal digital assistant (“PDA”) 108, and the cell phone 110. The provider server 102 is configured to communicate with the client computing device 106, the PDA 108, and the cell phone 110, via the network 118, which may be implemented as a Local Area Network (“LAN”), Wide Area Network (“WAN”), or the global network commonly known as the Internet. As known to those skilled in the art and others, the computing devices illustrated in FIG. 1 may be configured to exchange files, commands, and other types of data over the network 118. However, since protocols for network communication such as TCP/IP are well known to those skilled in the art of computer networks, those protocols will not be described here.

For the sake of convenience, FIG. 1 illustrates a server computer, a client computer, a PDA, and a cell phone that are usable in the networking environment 100 in which complementary tasks may be performed by remote computing devices linked together through the network 118. However, those skilled in the art will appreciate that aspects of the disclosed subject matter may be practiced with many other computer system configurations. For example, the disclosed subject matter may be practiced with a personal computer operating in a stand-alone environment or with multiprocessor systems, minicomputers, mainframe computers, and the like. In this regard, the functions performed by the computing devices described herein, may be implemented by a plurality of computing devices. For example, while the provider server 102 is illustrated as a single computing device, server-based functionality is frequently handled in a “server farm” in which multiple servers cooperate in executing necessary tasks so that requests from potentially large numbers of users may be satisfied. Moreover, in addition to the conventional computer systems illustrated in FIG. 1, those skilled in the art and others will also recognize that the disclosed subject matter may be practiced on other kinds of computing devices, including laptop computers, tablet computers, or any device on which computer software or other digital content may be executed.

When software that performs the functions of the disclosed subject matter is implemented in a networking environment, such as the networking environment 100 illustrated in FIG. 1, the software provides a way for users of networked computers to readily obtain information about a condition such as skincare, dermatological, or cosmetic conditions. In one aspect, an interactive application and related systems are made available from the provider server 102 that allows users to generate input and receive desired data about a particular condition in a readily understandable and intuitive manner. The interactive application is characterized by the use of controls and graphics for obtaining input and otherwise interacting with the user regarding individualized skincare conditions and potential treatments. In one aspect, a user may select and activate various controls to generate input without being required to employ keyword-based techniques in order to access the desired information.

As will be appreciated by those skilled in the art and others, FIG. 1 provides a simplified example of one networking environment 100 suitable for implementing aspects of the disclosed subject matter. In other embodiments, the functions and features of the computing systems shown (e.g., the provider server 102, the client computing device 106, the PDA 108, and the cell phone 110) may be implemented using a greater number of computing systems or reduced to a single computing system.

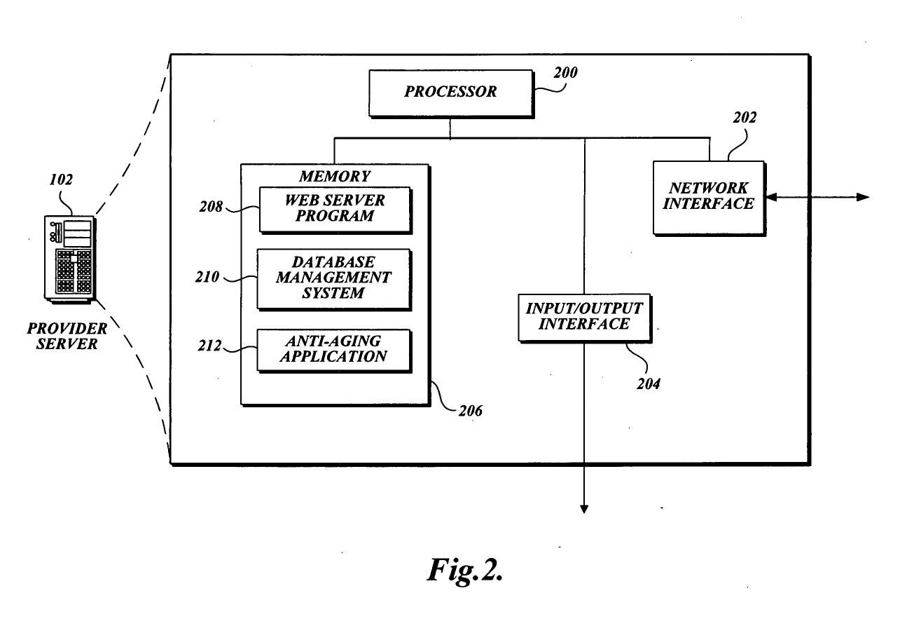

Now with reference to FIG. 2, an exemplary architecture of the provider server 102 depicted in FIG. 1 that illustrates components suitable to implement aspects of the disclosed subject matter will be described. Those skilled in the art and others will recognize that the provider server 102 illustrated in FIG. 2 may be any one of a variety of devices including, but not limited to, personal computing devices, server-based computing devices, mini- and mainframe computers, laptops, or other electronic device having some type of memory. In the embodiment of the provider server 102 illustrated in FIG. 2, the provider server 102 includes a processor 200 in communication with a variety of computing elements, including a network interface 202, an input/output interface 204, and a memory 206. As used herein, the term “computer-readable media” includes volatile and non-volatile and removable and non-removable media implemented in any method or technology capable of storing information, such as computer-readable instructions, data structures, program modules, or other data. In this regard, the memory 206 is merely one example of a computer-readable media.

The network interface 202 depicted in FIG. 2 enables the provider server 102 to communicate data, control signals, requests, and other information via a communication network (LAN, WAN, Internet, etc.) such as the network 118 described above with respect to FIG. 1. For instance, the provider server 102 may receive requests from other networked computing devices and transmit data back to a requesting computer over the network interface 202.

The input/output interface 204 enables the provider server 102 to communicate with various local input and output devices. An input device in communication with the input/output interface 204 may include computing elements that provide input signals to the provider server 102, such as a keyboard, mouse, external memory, disk drive, etc. Also, an output device in communication with the input/output interface 204 may include computing elements that accept output signals such as a monitor, a printer, and the like.

The processor 200 is configured to operate in accordance with computer program instructions stored in memory, such as the memory 206. As illustrated in FIG. 2, the memory 206 stores a Web server program 208, a database management system 210, and an anti-aging application 212. The Web server 208 illustrated in FIG. 2 comprises computer-executable instructions that, when executed by the processor 200, generates configurable markup documents (hereinafter referred to as “Web pages”), such as the sample Web pages described in more detail below. Moreover, the Web server program 208 provides a way for the provider server 102 to interact with users of other network-accessible computing devices. For example, the Web server program 208 is configured to generate Web pages and cause markup code to be accessible from the network 118 using standardized protocols. In an actual embodiment, the Web server program 208 is an Apache Web server developed by the Apache Software Foundation.

When a Web page is accessed, the Web server program 208 may receive data from a networked computing device that describes various types of user input. Received data may be used by the database management system 210 to query the database 104 for data that is relevant to a user request. Generally described, the database management system 210 provides functions allowing data in the database 104 to be updated, retrieved, or otherwise manipulated using queries. In this regard, the queries handled by the database management system include, but are not limited to, queries for adding, deleting, moving, retrieving, etc., data from the database 104. The database 104 may be queried and otherwise accessed using any one of the number of different scripting languages such as PHP, Perl, Python, etc. In an actual embodiment, the database management system 210 includes a MySQL database and related services available from MySQL AB, a Swedish corporation.

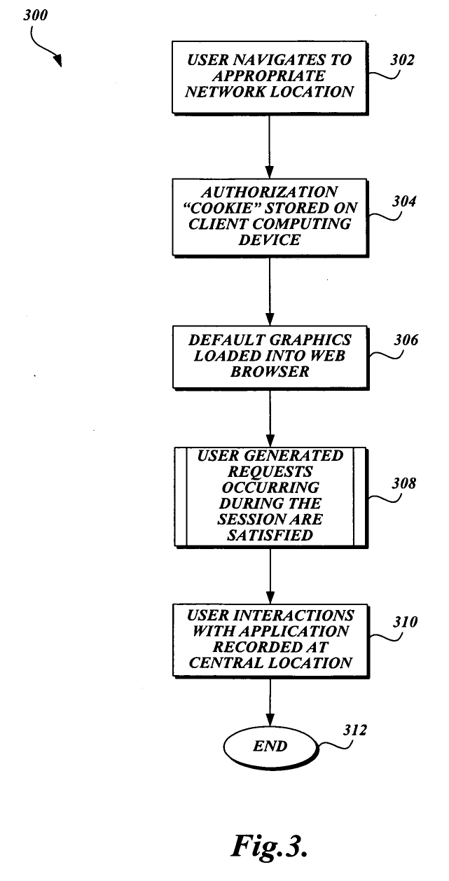

As further illustrated in FIG. 2, the memory 206 includes an anti-aging application 212 configured to allow relevant information about a condition to be accessed. In this regard, a remote user may initiate a session with the provider server 102 using any standard Web browser. Images and graphics may be displayed by the anti-aging application 212 that allows any user to readily input information using graphical controls regarding their age, gender, and skin color. Moreover, through a set of requests/response interactions with the application 212, and the interactive graphics that the application 212 provides, a user may provide input to select a condition of interest. Based on the input, the application 212 generates and displays information about the selected condition. In this regard, exemplary screen displays, methods, and other aspects of the application 212 are described below with reference to FIGS. 3-6. In one embodiment, the application 212 provides an interactive interface implemented using Adobe® Flash and Flex framework. However, those skilled in the art and others will recognize that the application 212 could be implemented utilizing other frameworks than those described herein, such as Microsoft® SilverLight, Asynchronous JavaScript and XML (AJAX), Java, Microsoft® .NET, etc.

Now with reference to FIG. 3, a method 300 illustrating an exemplary session in which a user interacts with the application 212 will be described. As illustrated in FIG. 3, the method 300 begins at block 302, where a user navigates to a network location in which functionality and resources of the application 212 are provided. As mentioned previously, a network location uniquely identified by a URL may be accessed using any standard Web browser program.

In one aspect, the application 212 is configured to serve multiple users with each user having a different user profile. To this end, the disclosed subject matter allows conditions that a user accesses to be saved to a user profile maintained in the database 104. Accordingly, initiating a session, at block 302, may include having a user “login” utilizing a username and password. In this instance, data involving a user's interactions with the application 212 may be recorded and/or accessed from a user profile maintained in the database 104. Even though a user may be authenticated with a user name and password, authentication is not required to access the functionality of the disclosed subject matter described herein.

At block 304 of the method 300, the provider server generates and transmits an authorization “cookie” for storage on the user's computing device. Upon initiating a session with the provider server 102, a cookie is transmitted to the appropriate client computing device (if one has not been transmitted previously) that allows user interactions with the application 212 to be tracked. Those skilled in the art and others will recognize that a “cookie” is a message transmitted from a Web server and managed on a client computing device by a Web browser. The Web browser is responsible for storing the message and may return the message to the Web server when, for example, the user requests a particular Web page or other network resource. As such, the utilization of a cookie allows aspects of the present disclosure to track users input and other interactions with the application 212. This data may be written to a user profile maintained in the database 104 so that users may recall information and conditions identified in other network sessions.

At block 306, default graphics for providing an anti-aging tour are loaded and rendered in the Web browser of the client computing device. In particular, default images and graphics used to obtain input from the user may be retrieved from the database 104 at the provider server 102. The default images and graphics are then transmitted to the client computing device with instructions that cause the images and graphics to be rendered by a corresponding Web browser. In this regard, the application 212 provides an interactive interface (“anti-aging tour”) in which a user may interact and readily access information about particular conditions, as described in further detail below.

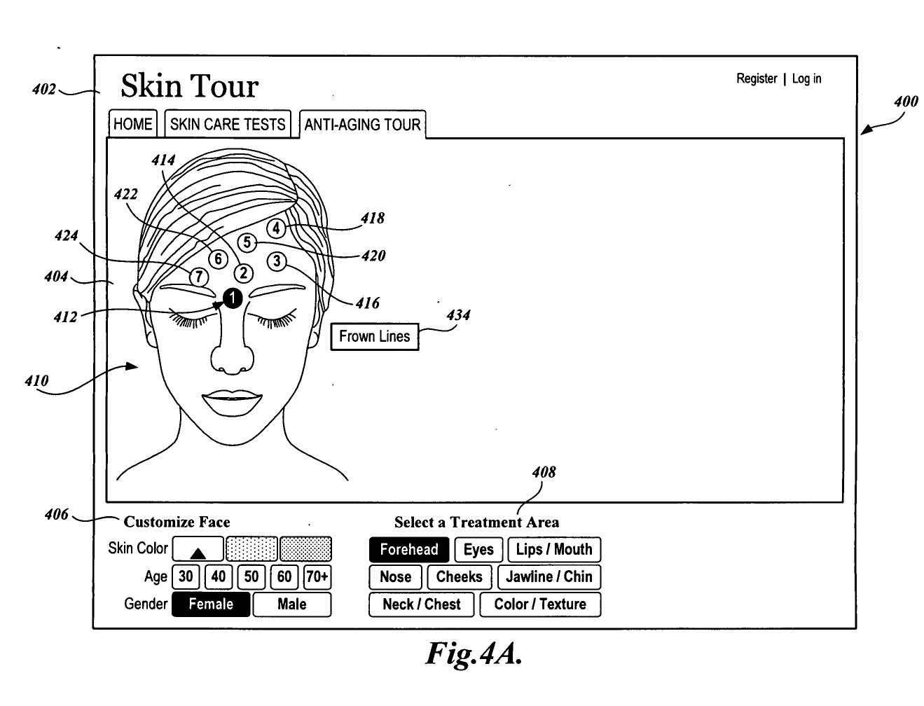

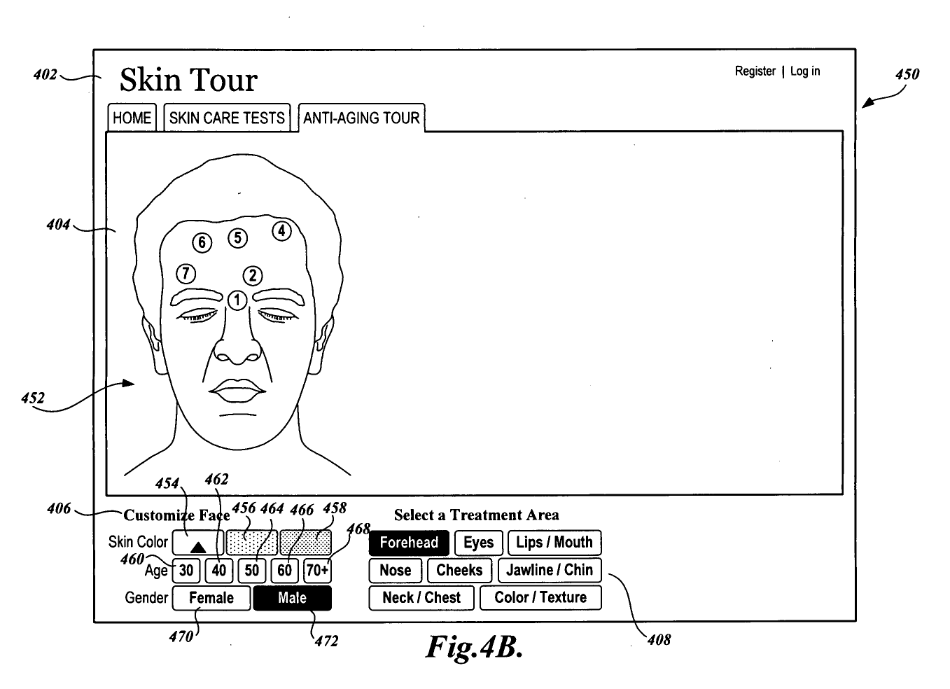

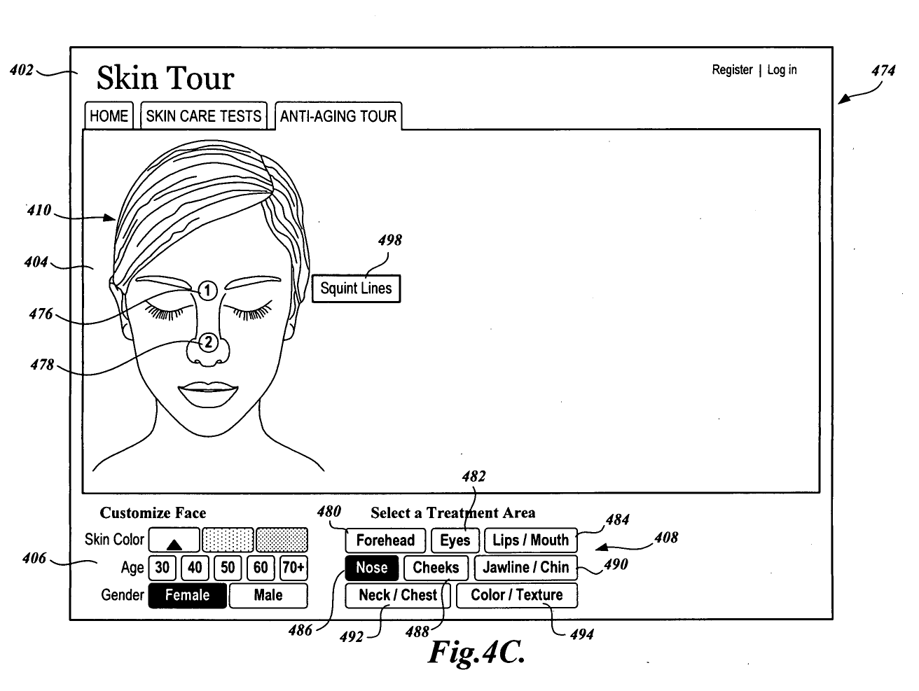

Now with reference to FIG. 4A, an exemplary Web page 400 of the type that may be rendered by a Web browser and displayed to a user at block 306 (FIG. 3) will be described. In one embodiment, a user may navigate to a network location in order to access the interactive interface provided by the disclosed subject matter. In response, a Web page (e.g., Web page 400) having default images and associated controls is rendered for display to the user. In the example depicted in FIG. 4A, the default images and graphics are displayed on the Web page 400 within the context of a header region 402, a graphics region 404, a customize region 406, and a treatment selection region 408.

As illustrated in FIG. 4A, the graphics region 404 includes an image 410 having embedded controls for navigating and otherwise accessing information related to a particular condition. The image 410 that is initially displayed is selected by default and may change based on user input. In this example, the image 410 includes embedded controls that may be highlighted and/or selected by the user. Specifically, the image 410 includes embedded controls in the form of numbered “hotspot” buttons 412-424. Each of the numbered hotspot buttons 412-424 may be highlighted by a user utilizing a mouse and pointer. In the example depicted in FIG. 4A, the user highlighted the hotspot button 412 causing the “FROWN LINES” dialog box 434 to be displayed. Once highlighted, a user may perform a selection event (e.g., by “double-clicking”) on the hotspot button 412 to obtain additional information about the corresponding condition.

With reference again to FIG. 3, one or more user-generated requests that occur in a session with the application 212 are satisfied, at block 308. Since the interactions and functionality provided by the disclosed subject matter in handling a set of request/response interactions with the application 212 are described in further detail below with reference to FIGS. 4B-6, further description of this aspect of the disclosed subject matter will not be provided here. However, as a user generates input regarding specific conditions, the information displayed to the user is dynamically updated. As a result, a user may readily navigate and obtain information about relevant conditions and treatment options without having to perform a keyword-based search. Additional examples of the types of requests that are handled by the disclosed subject matter at block 308 are described in further detail below.

At block 310 of the method 300, data describing a users interactions that occur during a session with the application 212 is recorded in a central location. As mentioned previously, user interactions with the application 212 may occur within the context of a session. When a user performs a logout or otherwise navigates away from the interactive interface provided by the disclosed subject matter, data describing the user's interactions during the session are transmitted back to the provider server 102. Utilizing the authentication cookie, the data describing interactions occurring during the session are written to a custom, user-defined profile maintained in the database 104. Then, once the data describing user interactions occurring within the session are written to the database 104, the method 300 proceeds to block 312, where it terminates.

Now with reference to FIG. 4B, additional aspects of the application 212 and the interactive interface that it provides will be described. Similar to FIG. 4A, the Web page 450 depicted in FIG. 4B includes the header region 402, the graphics region 404, the customize region 406, and the treatment selection region 408. In the embodiment depicted in FIG. 4B, a different image 452 than depicted in FIG. 4A is displayed. Specifically, the customize region 406 provides embedded controls in the form of the “SKIN COLOR” buttons 454-458, the “AGE” buttons 460-468, and the “GENDER” buttons 470-472. In this example, the “MALE” gender button 472 was activated by the user when the Web page 400 (FIG. 4A) was displayed, thereby providing input regarding the user's gender. In response, the image 410 (FIG. 4A) displayed by default is changed to the image 452 that is appropriate given the received input.

In response to the selection one of the controls 454-472 in the customize region 406, an image that is appropriate given the received user input is displayed. In particular, users may select between the “AGE” buttons 460-468 to have an image and related information displayed that is appropriate given the user's age. In each of these instances, an image of an individual within defined age range is displayed in the graphics region 404 in response to the received input. Moreover, a user may select between the “SKIN COLOR” buttons 454-458 to input information regarding this user attribute. Similar to the description provided above, the application 212 retrieves and displays an image of an individual within the defined skin color range in response to a selection involving one of the “SKIN COLOR” buttons 454-458.

Now with reference to FIG. 4C, another Web page 474 suitable for illustrating aspects of the present disclosure will be described. Similar to FIGS. 4A-4B, the Web page 474 depicted in FIG. 4C includes the header region 402, the graphics region 404, the customize region 406, and the treatment selection region 408. The graphics region 404 includes an image 410 also depicted and described above with reference to FIG. 4A. However, in this example, the image 410 includes a different set of “hotspot” buttons 476-478 than illustrated and described above. In this regard, the treatment selection region 408 provides embedded controls in the form of the buttons 480-494, for selecting between different areas of the human face. In this example, the “NOSE” button 486 was activated when the Web page 400 (FIG. 4A) was displayed to provide input regarding the treatment area of interest to the user. In response, the “hotspot” buttons 476-478 associated with the relevant area are presented to the user. In the example depicted in FIG. 4C, the user highlighted the hotspot button 478 causing the “SQUINT LINES” dialog box 498 to be displayed. Once highlighted, a user may perform a selection event (e.g., by “double-clicking”) on the hotspot button 478 to obtain additional information about the relevant condition.

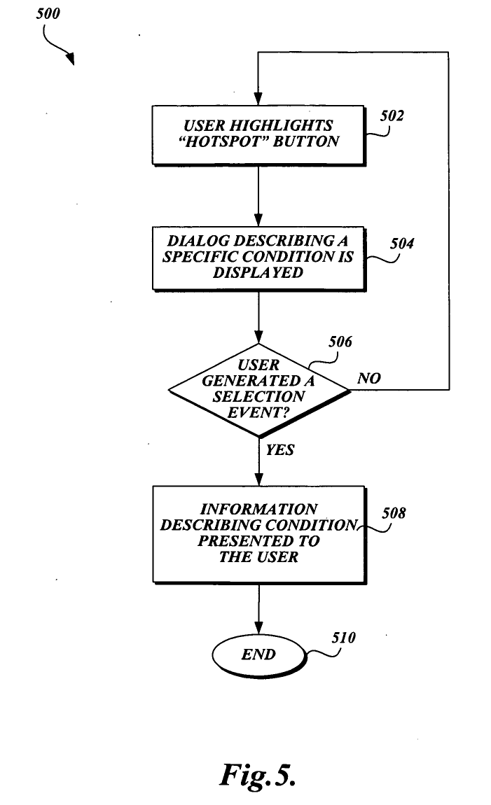

Now with reference to FIG. 5, a method 500 that handles a request for information about a specific condition will be described. As illustrated in FIG. 5, the method 500 begins at block 502, where a user highlights an embedded control associated with a specific condition. As described above with reference to FIGS. 4A-C, when a user moves a pointer over a particular “hotspot,” such as the hotspots 476-478, feedback is provided to indicate that the hotspot is active. Specifically, when activated, a hotspot is presented in a “highlighted” color to indicate that the pointer is within the area of the hotspot. Then, at block 504, the anti-aging application 212 causes a dialog box with text describing a highlighted condition to be displayed. For example, when the user highlights the hotspot button 412 depicted in FIG. 4A, the method 500 retrieves the appropriate text description and causes the “FROWN LINES” dialog box 434 to be displayed. When other hotspot buttons are highlighted, an appropriate condition description (i.e., wrinkles, broken blood vessels, receding hairline, etc.) is displayed.

At decision block 506, a determination is made regarding whether a user generated a selection event on a highlighted “hotspot” button. When a hotspot button is highlighted, a user may generate input to obtain specific information about the associated condition. For example, a user may perform a selection event by using a mouse to double-click on a particular hotspot button, such as the hotspot buttons described above with reference to FIGS. 4A-C. In instances when a highlighted hotspot button is not selected and the result of the test performed at block 506 is “no,” the method 500 proceeds back to block 502. In this instance, a user may activate and potentially select other hotspot buttons to identify a condition for which information is being sought. In contrast, if a user generates input to select a hotspot button and obtain additional information about a particular condition, the method 500 proceeds to block 508.

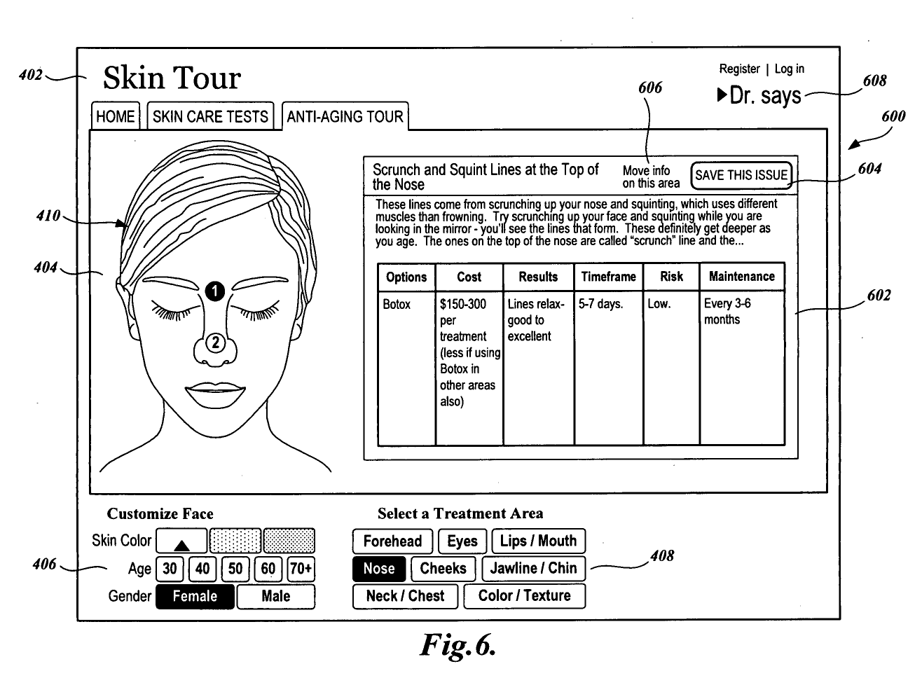

At block 508, specific information about a particular condition is made available to the user from an interactive user interface. In one aspect, the disclosed subject matter allows users to “drill down” and access specific treatment and product information associated with a selected condition. For example, if the user chooses one of the hotspot buttons made available from the Web pages described above, a “drill-down” table may be presented as shown and described in further detail below with reference to FIG. 6. In this regard, specific information about the selected condition and controls for accessing additional functionality is made available to the user from the “drill-down” table. To present specific information about a condition, the database 104 may be accessed and information related to the condition obtained. This data maintained in the database 104 may be pre-cached on the client computing device. Alternatively, information that is displayed to the user may be obtained dynamically in response to a user selection. As described in further detail below, the relevant information and related controls may be presented to the user in a “drill-down” table. Once the requested information is presented to the user, the method 500 proceeds to block 510, where it terminates.

Now with reference to FIG. 6, another exemplary Web page 600 suitable for illustrating aspects of the present disclosure will be described. Similar to FIGS. 4A-4C, the Web page 600 depicted in FIG. 6 includes the header region 402, the graphics region 404, the customize region 406, and the treatment selection region 408. In this example, the graphics region 404 includes an exemplary “drill-down” table 602 displaying information about a particular condition. The “drill-down” table 602 is presented, in this example, when a user selects the hotspot button 476 (FIG. 4C) associated with the “SQUINT LINES” condition.

As illustrated in FIG. 6, the drill-down table 602 presents information related to the selected condition including treatment options, costs, results, timeframe, risks, and maintenance. Each hotspot button potentially selected by a user is associated with a corresponding table for presenting information about a condition. From the drill-down table 602, additional controls are provided that may be selected. In particular, a user may activate the “SAVE THIS ISSUE” button 604 and have the selected issue saved to a user profile. As mentioned previously, a condition saved by a user is associated in the database 104 with a user profile and may be subsequently accessed on demand. In one aspect, a user may access all saved issues from a separate screen interface (not shown). The screen interface allows a user to add/remove specific conditions, e-mail information related to their saved conditions, download associated maintenance and treatment plans, and the like. Moreover, a user may activate the “MORE INFORMATION” button 606 or the “DR. SAYS” button 608 to access Web pages and interfaces having additional information about the selected issue.

Those skilled in the art and others will recognize that the highly granular level in which information about a condition may be accessed using the disclosed subject matter alleviates numerous shortcomings of existing systems. As described above, the disclosed subject matter provides users with a way to select and access detailed informational views about one or more conditions. However, it should be well understood that the Web pages described herein are merely exemplary of the types of features and data items that are made accessible to the user. In this regard a user may access additional types of data and features without departing from the claimed subject matter.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a computer networking environment that includes a provider server and at least one client computing device, a method of providing a user associated with the client computing device with information related to a condition, the method comprising:
providing a user interface having controls that allow the user associated with the client computing device to identify a relevant condition without performing a keyword search;
receiving input that identifies the relevant condition based on one or more selections of graphical controls presented on the user interface; and
presenting information associated with the relevant condition to the user.

2. The method as recited in claim 1, further comprising allowing a user to save the condition and recall information about the relevant condition during a different session.

3. The method as recited in claim 1, wherein providing a user interface having controls that allow the user associated with the client computing device to identify a relevant condition includes causing an authentication cookie to be stored on the client computing device.

4. The method as recited in claim 1, wherein providing a user interface having controls that allow the user associated with the client computing device to identify a relevant condition includes providing a layered input schema in which a user initially selects a treatment area and subsequently activates a hotspot button within the selected treatment area.

5. The method as recited in claim 1, wherein providing a user interface having controls that allow the user associated with the client computing device to identify a relevant condition includes initiating a network session with the client computing device in which the identity of the user is authenticated.

6. The method as recited in claim 1, wherein receiving input that identifies the relevant condition based on one or more selections of graphical controls includes tracking interactions that occur during the network session and recording the interactions in a centralized data store upon termination of the network session.

7. The method as recited in claim 1, wherein presenting information associated with the selected condition to the user includes querying a database and presenting a drill down table that includes at least one option for treating the condition.

8. An interactive user interface implemented in instructions that are executed by a computer processor, the interactive user interface operative to:
present a graphical image on a Web page having designated hotspot locations within the screen area of the graphical image, wherein each hotspot location corresponds to a condition in which a detailed informational view can be accessed;
provide a text-based description of a condition when a hotspot location on the graphical image is highlighted;
in response to a selection of a hotspot location:
retrieve a set of information related to a condition that corresponds to the selected hotspot location; and
present a detailed informational view on the interactive user interface that includes at least one option for treating the condition.

9. The interactive user interface as recited in claim 8, further configured to:
accept input using graphically based controls that describe a user attribute from the group of skin color, age, and gender;
cause a different image to be displayed that matches the received input.

10. The interactive user interface as recited in claim 8, further configured to provide a layered input schema in which a user initially identifies a treatment area and subsequently selects a hotspot location within the selected treatment area.

11. The interactive user interface as recited in claim 8, further configured to accept input for selecting a particular treatment area and cause hotspot locations that correspond to the selected treatment area to be displayed.

12. The interactive user interface as recited in claim 8, wherein to present a detailed informational view includes presenting a drill down table having entries associated with the condition including at least one of cost, result, timeframe, risk, and maintenance.

13. The interactive user interface as recited in claim 8, wherein to present a detailed informational view includes allowing a user to save information that describes the condition for access in a different network session.

14. The interactive user interface as recited in claim 8, wherein a user is able to access a detailed informational view about a condition without performing a keyword search.

15. A computer-readable medium containing computer-readable components for disseminating information about a condition, the computer executable components, including:
an image customization component configured to accept input using graphically based controls that describe a users skin color, age, and gender;
an area selection component operative to accept input describing an area in which a condition may exist;
a condition selection component configured to:
present designated hotspot locations that each correspond to a condition in which a detailed informational view can be accessed;
receive a selection of a hotspot location; and
present a detailed informational view that includes at least one option for treating the condition.

16. The computer-readable medium as recited in claim 15, further comprising a server side component operative to cause an interactive user interface to be loaded into the browser of a client computing device, retrieve detailed information views about one or conditions from a database, and record a set of user interactions that occur during a network session.

17. The computer-readable medium as recited in claim 16, wherein the server-side component is further configured to maintain a user profile in which users are allowed to save one or more conditions.

18. The computer-readable medium as recited in claim 15, wherein the area selection component is operative to accept input describing a treatment area in which the condition may exist and wherein the condition selection component is further operative to present designated hotspot locations within the identified treatment area.

19. The computer-readable medium as recited in claim 15, wherein a user is able to access a detailed informational view about a condition without performing a keyword search.

20. The computer-readable medium as recited in claim 15, wherein in response to a hotspot location being highlighted the condition selection component causes a text description of a condition to be presented.
